(19) United States
(12) Patent Application Publication
(10) Pub. No.: US 2026/0236372 A1
(43) Pub. Date: Aug. 13, 2026

(54) DEBUGGING SYSTEM

(71) Applicant: Undo Ltd., Cambridge (GB)

(72) Inventor: Edward Tait, Cambridge (GB)

(21) Appl. No.: 19/049,592

(22) Filed: Feb. 10, 2025

(51) Int. Cl. G06F 11/362; G06F 11/3604

(52) U.S. Cl. CPC G06F 11/3644; G06F 11/3612

(57) ABSTRACT

Methods for identifying anomalous execution of a computer program. One method includes, during a replay of a first recording of a first execution of the computer program, (a) for each access attempt to each one of one or more first regions of memory: storing an address of the first region; storing an identifier of a thread attempting to access the first region; and providing access, to the thread, to a value stored in the first region at the time of the access attempt, (b) identifying, based on the stored addresses and identifiers, one or more pairs of first and second threads that attempted to access a same first region during the replay, and (c) generating a second recording of a second execution of the computer program where the pairs of first and second threads are processed in a different order than the first execution.

### FIELD OF THE INVENTION

This invention relates to methods, apparatus and computer program code to facilitate the analysis of computer programs to identify anomalous execution.

### BACKGROUND TO THE INVENTION

When writing computer programs it is sometimes the case that errors, or ‘bugs’, are included in the program. Sometimes this is due to typographical errors in writing source code (e.g. omitting a character or substituting one character for another), sometimes due to implementing incorrect functionality (e.g. causing a loop to terminate at one when it ought to terminate at zero) and sometimes due to errors in other programs upon which an author of the program is relying, for example a library routine or even the compiler itself.

A debugger can assist users in identifying and removing bugs from a program. Prior art debuggers tend to focus upon inserting so-called breakpoints into a program and running a program forwards in time, stopping at one or more of the breakpoints in order to examine the state of the program (content of processor registers, content of memory) at that breakpoint in the hope of catching an error before it causes the program to crash. Crashing can take many forms, generally summarised as the program not running as intended, for example a segmentation fault, an unhandled exception or an infinite loop (where a program stops responding to user input and executes the same routines indefinitely). An example of such a prior art debugger is GDB, the GNU Project Debugger.

Some debuggers can work backwards as well as forwards. For example, in WO2007/045920, which is incorporated by reference in its entirety, techniques are described which allow a program, more particularly the program code of a program, to effectively be run backwards. This is helpful as it allows an error to be traced backwards from the moment it caused the program to crash until the error first appeared.

Whilst backwards execution of a program is useful in debugging, it would be useful to have additional tools to make the debugging process easier and faster.

### SUMMARY OF THE INVENTION

In a first example described herein, there is a computer-implemented method for analysing a computer program to identify anomalous execution, comprising: initiating a replay of a first recording of an first execution of the computer program; during the replay of the first recording, for each access attempt to each one of one or more first regions of memory: storing an address of the first region of memory; storing an identifier of a thread attempting to access the first region of memory; and providing access, to the thread, to a value that was stored in the first region of memory at the time of the access attempt; identifying, based on the stored addresses and the stored identifiers, one or more pairs of first and second threads that attempted to access a same first region of memory during the replay of the first recording; generating a second recording of an second execution of the computer program comprising, during the second execution and for each of the identified one or more pairs of first and second threads: processing the first and second threads in a different order to that processed in the first execution; and initiating a replay of the second recording.

By identifying pairs of first and second threads and processing the first and second threads in this way, anomalous behaviour may be reproduced, and thus resolved, quicker than otherwise. That is, the first and second threads both changing a value stored in a same first region of memory may, in certain circumstances, cause a bug to occur. By use of the method, the certain circumstances, and thus the bug, may be reproduced quicker.

It will be appreciated that each of the threads may be a virtual thread. That is, each of the virtual threads may be performed on a single kernel thread. Alternatively, each of the threads may be a kernel thread.

It will also be appreciated that each replay of the recordings may be a partial replay. That is, it may not be necessary to replay the entire recordings. Each of the recordings of an execution of the computer program may be a recording of a portion of an execution of the computer program. In other words, each of the recordings may not be a recording of the entire computer program being executed.

It will be further appreciated that generating the second recording may comprise executing the second execution of the computer program.

Each of the replays may start at any appropriate time point. In other words, initiating a replay may comprise initiating a replay that starts partway through the recording.

The one or more first regions of memory may be a plurality of first regions of memory.

The method may further comprise generating, from a first recording of an execution of the computer program, a modified first recording; and wherein initiating the replay of the first recording may comprise initiating replay of the modified first recording.

The modified first recording may be generated prior to initiating the replay of the first recording. That is, initiating the replay of the first recording may comprise initiating the replay of the modified first recording.

Generating the modified first recording may comprise identifying the one or more first regions of memory as regions of memory accessed by an execution of a computer program in the first recording; for each one of the one or more first regions of memory: assigning a value stored in the first region of memory at a first recording time point to a corresponding second region of memory; and setting a property of the first region of memory to cause an access condition to occur upon attempted access of the first region of memory during a replay of the modified first recording; wherein, the method may further comprise, during the replay of the first recording: detecting the access condition.

Put differently, for each of the one or more first regions of memory, there is a respective second region of memory that has been assigned a value stored in the first region of memory.

The access condition may be any appropriate condition. In particular, the access condition occurring may cause detail of the access condition to be provided to a tracing process. For example, if the access condition occurs due a memory not being accessible, an address of the inaccessible memory may be provided with, or as part of, the condition. As an example, the access condition may be a segmentation fault.

The address of the first region of memory may be stored in response to the access condition being detected. The identifier of the thread attempting to access the first region of memory may be stored in response to the access condition being detected. As an example, the address of the first region of memory and the identifier of the thread may be stored in a map.

Access may be provided, to the thread, to the value that was stored in the first region of memory in the first recording at the time of the access attempt in response to the access condition being detected.

It will be appreciated that the same access condition may cause the address of the first region of memory to be stored, the identifier of the thread attempting to access the first region to be stored and the access to the value that was stored in the first region to be provided.

Providing access, to the value that was stored in the first region of memory in the first recording at the time of the access attempt may comprise: providing access to the corresponding second region of memory.

Setting the property of the first region of memory may comprise setting an access permission of the first region of memory. In some examples, setting the access permission may comprise removing a read permission. Additionally or alternatively, setting the access permission may comprise removing a write permission and/or execution permission. In particular, the access permission of the first region of memory may be set such that the memory cannot be accessed at all. For example, the access permission may be set to PROT_NONE. The access permission may be an access permission for a process corresponding to the replay of the first recording.

The method may further comprise, during the replay of the first recording, for each access attempt: storing a program counter value. For example, the program counter value may be an offset value. Beneficially, by storing a program counter value, the method may be robust to address space layout randomization (ASLR). That is, the method may store an indication of an instruction which caused the access attempt to the first region of memory. Thus, from the indication of the instructions, corresponding code may be identified and indicated to a user.

The method may further comprise identifying, based on the stored program counter values and the stored addresses, one or more program counter values corresponding to attempts to access the same first region of memory during the replay of the first recording; and outputting an indication of the one or more program counter values. In other words, the method may indicate which code caused the first and second threads to attempt to access the same first region of memory during the replay of the first recording.

Generating the modified first recording may comprise scheduling the first and second threads in a first order; and generating the second recording may comprise scheduling the first and second threads in a second order. The first order and the second order may be different.

It will be appreciated that portions of threads may be scheduled in a different order. In some examples, entire threads may be scheduled in a different order.

In some examples, the second order may be determined based on the stored program counter value. In particular, the second order may be determined based on the one or more program counter values corresponding to attempts to access the same first region of memory during the replay of the first recording.

The method may further comprise generating the first recording. In some examples, the first recording may be indicative of a bug. That is, the first recording may demonstrate the bug occurring. In other examples, the first recording may not demonstrate the bug occurring. That is, by use of the method, a bug may be recreated or found without being demonstrated in the first recording. The first recording of the execution of the computer program may be captured by a debugger, for example, a backwards debugger.

The method may further comprise receiving the first recording.

Storing the address of the first region of memory may comprise storing a rounded address of the first region of memory.

Storing the identifier of a thread attempting to access the first region of memory may comprise storing a rounded identifier of the thread attempting to access the first region of memory.

There is also described herein a computer system comprising a memory storing processor readable instructions; a processor arranged to read and execute instructions stored in the memory; wherein the processor readable instructions are arranged to cause the processor to carry out any one or more of the methods or method steps described herein.

There is also described a non-transitory computer readable medium comprising processor readable instructions, wherein the processor readable instructions are arranged to cause a processor to carry out any one or more of the methods or method steps described herein.

### BRIEF DESCRIPTION OF THE DRAWINGS

The operation of an example backwards debugging system, in the context of which aspects and embodiments of the invention may operate, is described with reference to the accompanying drawings in which:

FIG. 1 shows a running program with snapshots at regular 2 second intervals;

FIG. 2 shows an example Linux program;

FIG. 3 shows an example of a computer system;

FIG. 4 shows a flowchart showing the instrumentation algorithm;

FIG. 5 shows the program P and its instrumented counterpart P′;

FIG. 6 shows interception of asynchronous events;

FIG. 7 is a flowchart of an example method for analysing a computer program;

FIG. 8 is a flowchart of an example method for generating a modified first recording;

FIG. 9 is a flowchart of an example method of replaying a recording of an execution of the computer program;

FIG. 10A shows a first order of processing threads;

FIG. 10B shows a second order of processing threads;

FIG. 10C shows a third order of processing threads; and

FIG. 11 is a schematic depiction of a computer system on which techniques described herein may be implemented.

### DETAILED DESCRIPTION

We first describe some backwards debugging systems which may be used with others of the techniques described herein.

Broadly a backwards debugger allows a program to be executed in such a manner that it appears that the execution is backwards, that is in a reverse direction to the normal direction of program code execution. Thus in a backwards debugger is a debugger that allows a program being debugged to be rewound to an earlier state, and then allows the user to inspect the program's state at that earlier point. Such a debugger ideally provides commands to allow the user to step the program back in small well-defined increments, such as single source line; a machine instruction; step backwards into, out of, or over function calls and the like.

We will describe bidirectional or backwards debugging where (preferably) substantially the complete state of a running computer program can be examined at any point in that program's history. This uses a mechanism to ‘unwind’ the program's execution. This is a difficult problem, because as a program executes previous states are generally irretrievably lost if action is not taken to record them (for example, writing to a memory location causes whatever information was previously at that memory location to be lost). There are two approaches to solving this problem: firstly to log every state transition as the program executes; secondly, to re-execute the program from an earlier recorded state to reach the desired point in its history. The first suffers from several problems, including slow forwards execution of the program, and the generating of large amounts of data as the program executes. The second approach is generally more efficient but requires that non-determinism be removed on re-execution so that the program follows exactly the same path and transitions through exactly the same states each time it is re-executed.

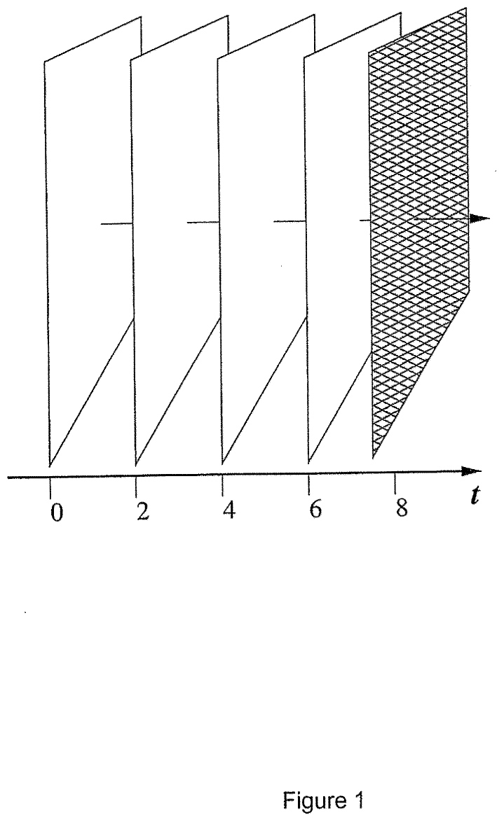

We describe a mechanism whereby a ‘snapshot’ is periodically taken of a program as it runs. To determine the program's state at a given time t in its history, we start with the snapshot taken most recently before time t, and execute the program forwards from that snapshot to time t. For example, FIG. 1 depicts a program under execution. The program has been running for a little over 7 seconds, with snapshots having been taken every 2 seconds. In order to find the state of this program at t=5 s the snapshot taken at 4 s is replayed for 1 s. We use the inherent determinism of a computer to ensure that the when the snapshot of the program is replayed to time t, it will have exactly the same state as had the original program at time t. The UNIX fork system call provides one mechanism to snapshot a process.

Unfortunately, while a computer itself is deterministic, computer programs do not run deterministically, due to non-deterministic inputs. That is, when we say a computer is deterministic we mean that given the same set of inputs, it will always run through the same state changes to the same result. Therefore, if we wish to ensure that a snapshot of a program is replayed exactly as the original, we should ensure that exactly the same inputs are provided to the replayed program as were provided to the original.

Fortunately, most modern, ‘protected’ operating systems provide a sanitised ‘virtual environment’ in which programs are run, commonly referred to as a process. An important feature of processes in this context is that they strictly limit the computer resources that are accessible to a program, making it practical to control all sources of non-determinism that may influence a program's execution. These resources include the memory that is accessible by the process, as well as operating system resources, such as files and peripherals. We define all such resources as the process state. The memory and register set of a process make up its internal state, while operating system resources that it may access make up its external state. The controlled environment of a process means that with the help of instrumentation it is practical to eliminate substantially all significant sources of non-determinism during execution of the process.

We have identified four categories of non-determinism for a computer process executing on a protected operating system:
1) Non-deterministic instructions are instructions which may yield different results when executed by a process in a given internal state. The most common form of non-deterministic instruction is the system call (i.e. the instruction used to make a request of the operating system). For example, if a process issues a system call to read a key press from the user, the results will be different depending on which key the user presses. Another example of a non-deterministic instruction is the Intel IA32 rdtsc instruction, which obtains the approximate number of CPU clock ticks since power on.
2) A program executing multiple threads will show non-determinism because the threads' respective transactions on the program's state will occur in an order that is non-deterministic. This is true of threads being time-sliced onto a single processor (because the operating system will time-slice at non-deterministic times), and of threads being run in parallel on multiprocessor systems (because concurrent threads will execute at slightly different rates, due to various external effects including interrupts).
3) Asynchronous events are events issued to the process from the operating system that are not the direct result of an action of that process. Examples include a thread switch on a multithreaded system, or a timer signal on a UNIX system.
4) Shared memory is memory that when a location read by the program being debugged does not necessarily return the value most recently written to that location by the program being debugged. For example, this might be because the memory is accessible by more than one process, or because the memory is written to asynchronously by the operating system or by a peripheral device (often known as DMA—Direct Memory Access). As such out-of-band modifications are performed outside of the context of the program being debugged, this may result in non-determinism during re-execution.

Preferably a bidirectional or backwards debugging system should be able to work in all circumstances, and preferably therefore the aforementioned sources of non-determinism should be eliminated. To achieve this, all non-deterministic events are recorded as the debugged process executes. When replaying from a snapshot in order to obtain the program's state at some earlier time in history, the recorded non-deterministic events are faithfully replayed. The mechanism used to employ this is described in the following section.

We employ a technique of machine code instrumentation in order to record and replay sources of non-determinism. Our instrumentation is lightweight, in that it modifies the instrumented program only slightly, and is suitable for use with variable length instruction sets, such as Intel IA32.

We instrument by intercepting control flow at regular intervals in the code. Sections of code between interception are known as basic blocks. A basic block contains no control flow instructions, and no non-deterministic instructions—that is, a basic block contains no jumps (conditional or otherwise) or function calls, nor system calls or other non-deterministic instructions, or reads from shared memory. Control flow and non-deterministic instructions are therefore termed basic block terminators.

An instrumented program is run such that all the basic blocks are executed in the same order and with the same results as would be the case with its equivalent uninstrumented program. The instrumentation code is called between each basic block as the instrumented program executes. Each of the program's original basic blocks are copied into a new section of memory, and the basic block terminator instruction is translated into one or more instructions that ensure the instrumentation code is called before control continues appropriately.

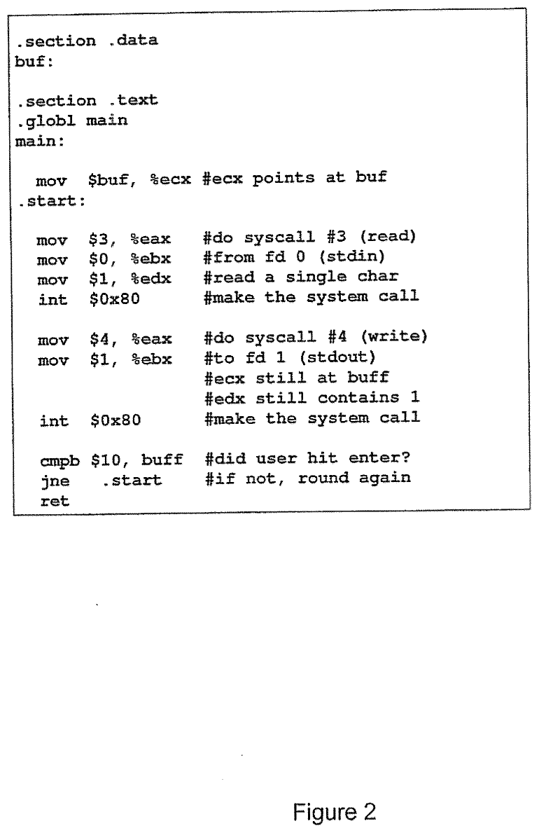

As an example, consider the Linux program shown in FIG. 2, written in Intel IA32 assembler (using GNU/AT&T syntax).

This simple program reads characters from stdin, and echos them to stdout. The program contains four basic blocks, terminated respectively by the two int $0x80 instructions, the jne and the ret instruction at the end.

For convenience, we term the uninstrumented program P, and its instrumented equivalent P′. For each basic block there is an uninstrumented basic block Bₙ, and a corresponding instrumented basic block B′ₙ.

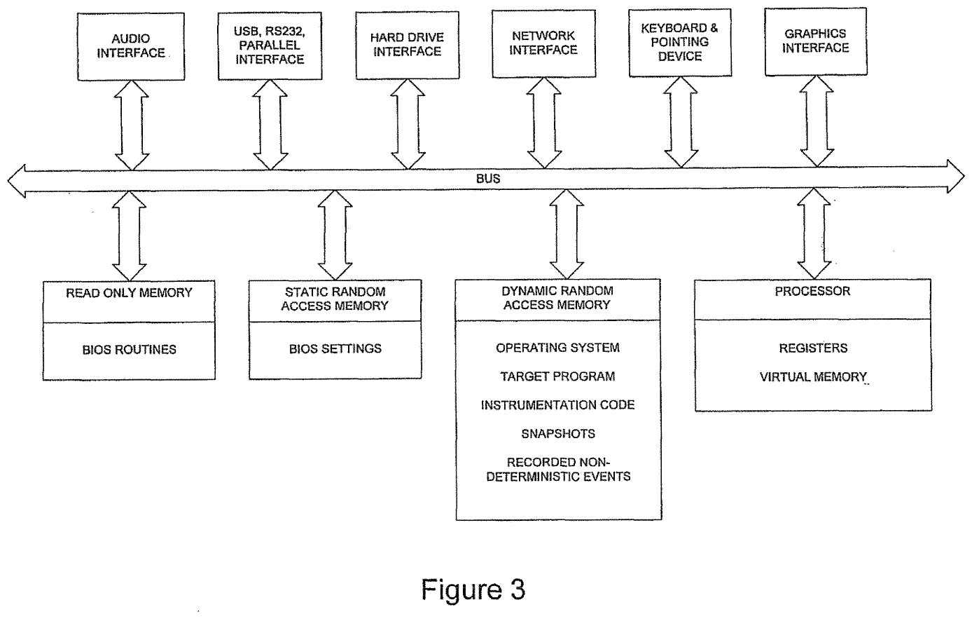

FIG. 3 shows an example of a computer system on which the program may be executed and on which bi-directional debugging may be performed. The target program and the debugger both reside in physical memory. Processor registers may be captured and stored in snapshots along with memory used by the target program process. The debugger may operate within the virtual memory environment provided by the processor and the operating system, or it may operate on a single process computer.

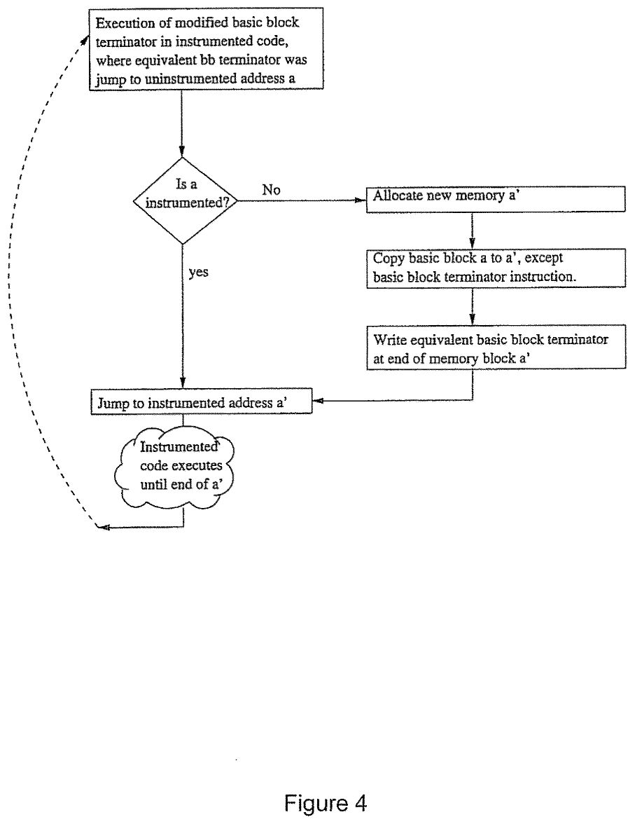

FIG. 4 shows a flowchart that illustrates the instrumentation algorithm. (Note that algorithm instrumented code in an ‘on-demand’ fashion, as that program executes; an ahead of time algorithm is also practical.)

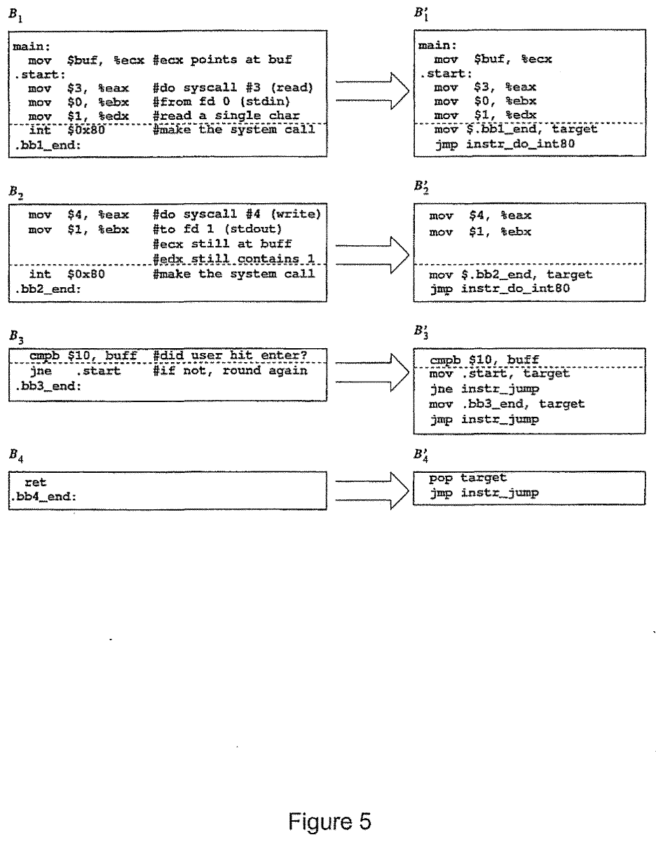

FIG. 5 shows the program in the previous example broken into its four basic blocks, and how those basic blocks are copied, and how the basic block terminator instruction for Bₙ is replaced in B′ₙ with one or more instructions that branch into the instrumentation code. The label target is used to store the uninstrumented address at which control would have proceeded in the uninstrumented version of the program; the instrumentation code will convert this to the address of the corresponding instrumented basic block and jump there.

The copying and modifying of basic blocks for instrumentation may be carried out statically before the program is executed, or may be done dynamically during the program's execution (i.e. on demand). Here, when the instrumentation code looks up the address of an instrumented basic block given the corresponding uninstrumented address, if the instrumented version cannot be found then the uninstrumented block is copied and the basic block terminator translated. (Our implementation uses the dynamic approach.)

We will next describe making replay deterministic. Using the instrumentation technique described in 3 we are able to remove all sources of non-determinism from a process. We deal with each of the four kinds of determinism separately in subsections below.

Non-deterministic instructions: During the reference execution the results of all non-deterministic instructions (including system calls) are recorded in an event log. When playing a process forwards from a snapshot in order to recreate a previous state, the process is said to be in ‘replay mode’. Here, the instrumentation code ensures that non-deterministic instructions are not executed, and instead their results are synthesised using data stored in event log. There the process' internal state is artificially reconstructed to reflect the results of the corresponding non-deterministic instruction produced during the reference execution.

For example, when replaying a system call, this means restoring the system call's return code, as well as any of the process's memory that was modified as a result of the system call.

External state (operating system resources): Note that it is not necessary to reconstruct the process' external state when recreating the results of non-deterministic instructions, because the process' interaction with its external state is in general governed entirely through system calls. For example, consider a process the opens a file for reading during the reference execution. The process will receive a file descriptor (also known as a file handle) which it will use with future calls to the OS to read from the file. The file descriptor is obtained and used with system calls. These system calls will be shortcut in the replay process. In effect, the instrumentation code will ensure that the replay process ‘believes’ that it has the file open for writing, but in fact it does not.

However, this is not true for OS resources that are visible from the process' internal state. As an example, consider a call to the OS to expand a process' address space (i.e. the memory it can access). Since this affects a resource which the replay process will access directly (i.e. memory), this system call should be reissued on replay to ensure that the effects of the non-deterministic instruction in question are faithfully replayed.

Note that memory mapped files are not treated specially; the entire contents of the file that is mapped are preferably recorded in the event log so that the effects of the memory map operation may be replayed. This is because the memory mapped file may be in a different state (or may not even exist) during replay. However, it is possible to optimise this case by recording and replaying the on-demand mapping of pages of such files. Here, when a process maps a file during the reference execution, the instrumentation code ensures that the process does not really map the file, although the instrumented program is ‘unaware’ of this. This means that when the process attempts to access the pages of the file it believes are mapped, it will fault. The instrumentation code intercepts these faults, and maps the pages from the file, recording the contents of those pages in the event log. On replay, again the file is not mapped. However, this time when the replay process faults accessing the pages, the instrumentation code obtains the contents of those pages from the event log, and maps the pages and initialises them appropriately. Alternatively, memory mapped files may be considered as shared memory, and dealt with as described below.

Asynchronous events: It is important that asynchronous events are replayed substantially exactly as they occur during the reference execution. During the reference execution, we use instrumentation to obtain a sufficient level of control over when asynchronous events happen, so that these events may be faithfully reproduced in replay mode. This means that all asynchronous events are preferably delivered to the instrumented program at basic block boundaries.

Asynchronous messages: Many modern operating systems provide a facility where an application can register an asynchronous event handling function. When the asynchronous event occurs, the operating system interrupts the program, transferring control directly to the handler function. When the handler function returns, the program proceeds as before interruption. This mechanism may be referred to as asynchronous signal delivery, or software interrupt servicing.

Such asynchronous events are preferably controlled to ensure that they are essentially entirely repeatable. To achieve this, during the reference execution, the instrumentation code intercepts system calls to set up a handler for an asynchronous message. The request is manipulated such that the instrumentation intercepts asynchronous messages.

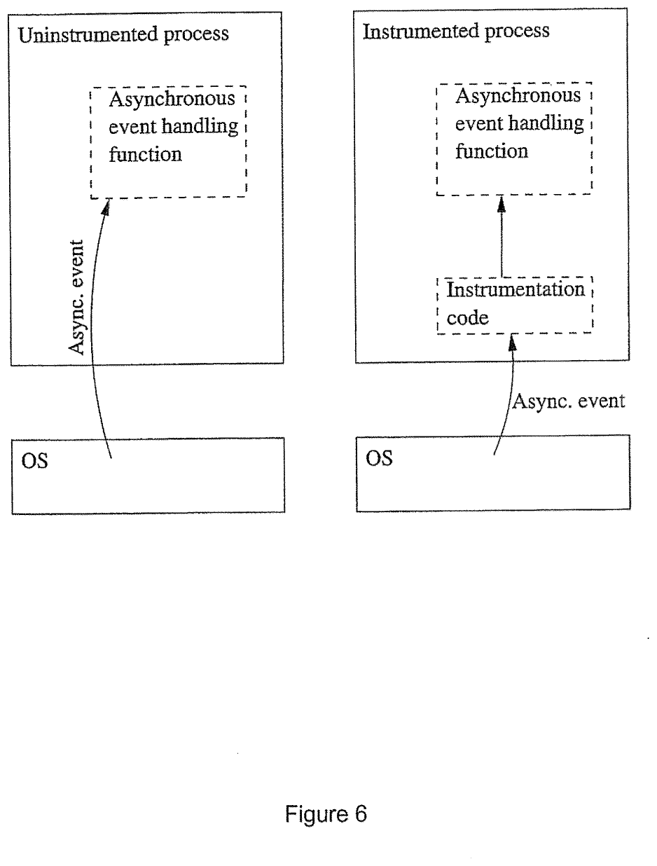

This is depicted in FIG. 6. The instrumentation code does not deliver the asynchronous notification directly to the program (i.e. it will not directly call the program's asynchronous event handler function). Instead the instrumentation code's event handling function record the asynchronous event to the event log, and then arrange for the event handler to be executed under the control of instrumentation.

When replaying, asynchronous events are not delivered to the replay process at all. Instead, each time a basic block is executed, the event log is checked. If an event is scheduled for the current basic block, then the process's event handling function is called, thus faithfully replaying the asynchronous event.

As well as providing determinism, this mechanism also ensures that the asynchronous event handling function is instrumented when it is called. Otherwise, if the operating system is allowed to call the program's event handling function directly, then the original, uninstrumented code will be called, and we will ‘lose’ instrumentation.

Note that message-based systems such as Microsoft Windows® use a system call to retrieve the next message from a message queue; the mechanism outlined above covers this case.

Threads: There are two main ways to implement multithreading within a process: kernel managed threads, and user managed threads. With user-managed threads, a user-mode library is responsible for threading. Thread pre-emption is performed by the library by responding to asynchronous timer events—hence any non-determinism resulting from user-managed multithreading can be removed using the techniques described above with reference to Asynchronous events.

However, most modern computer systems use kernel-managed threads. Here the operating system kernel is responsible for switching and otherwise managing threads, in general entirely without direct support from the application. There are several mechanism that can be employed to obtain deterministic kernel-managed threads.

One technique is to use the instrumentation code to implement ‘virtual-kernel-managed threads’, which involves the instrumentation code effectively providing user-managed threads, but letting the application ‘believe’ it is using kernel managed threads. Here, the system call to create a new kernel managed thread is intercepted by the instrumentation code, and subverted such that the instrumentation code creates a virtual kernel-managed thread within the single real kernel managed thread. The instrumentation code multiplexes all virtual kernel-managed threads onto a single real kernel-managed thread. This means that thread switching is under control of the instrumentation code and can be made essentially entirely deterministic. The instrumentation code can provide pre-emptive multithreading by effecting a virtual kernel-managed thread switch every n basic blocks (e.g. where n=10,000).

Here, care must be taken if we wish to ensure deadlock is avoided. If a virtual kernel-managed thread blocks waiting for the action of another virtual kernel-managed thread, since both virtual threads are running within a single real thread, deadlock can result. (A particularly common example of this problem is when two virtual kernel-managed threads contend on a mutual exclusion primitive; if care is not all virtual kernel-managed threads will deadlock). One way to avoid deadlock on a UNIX system to periodically arrange for the process to be delivered an asynchronous timer signal, such that blocking system calls will be interrupted, returning EINTR.

An alternative mechanism involves letting the program create kernel-managed threads as normal, but subverting the thread creation such that the instrumentation code has control over which thread is executing at which time. This might involve modifying the threads' priorities such that the instrumentation code can control which thread the OS will execute, or perhaps artificially blocking all but one thread at a time by e.g. having all kernel managed threads contend on a single kernel-managed mutex (which we shall call ‘the debugging mutex’). This technique would also suffer a similar deadlock problem referred to above. Here if the kernel-managed thread that owns the mutex waits for an operation to be completed by another thread, the system will deadlock. (This is because the other thread will never be able to complete its work because it is waiting for the debugging mutex, yet the thread that owns the debugging mutex will never release it because it is waiting for that other thread.) Fortunately, the only way a thread can block awaiting the result of another is through a system call. Therefore, this problem can be overcome by ensuring that any thread drops the debugging mutex before entering any system call that may block, and then takes it again on return from said system call (note that there is no problem if a thread “busy-waits” because eventually it will execute a maximum number of basic blocks and then drop the debugging mutex). However, if the debugging mutex is to be dropped when a system call is issued, care must be taken to ensure that the system call does not modify the program's internal state in a way that voids determinism. For example, if the system call is reading data off the network and writing that data into the program's address space while concurrently another thread that holds the debugging mutex is reading that same memory, non-deterministic behaviour will result. Fortunately, this problem can be avoided be having the system call read not into the program's internal state, but into the event log. After the debugging mutex has been taken on behalf of the thread that issued the system call, then the data that was read by the system call into the event log can then be copied into the program's internal state. This trick can be implemented with relatively little work, since we already have the requirement that system calls that write into user memory have their results stored in the event log. Therefore, rather than have the system call read into program memory and then copying that data into the event log, we instead subvert parameters to the system call such that data is read directly into the event log, and have the instrumentation code subsequently copy from the event log into program memory, but only once the debugging mutex has been taken.

Shared memory: If a process being debugged shares memory with another process, it is possible to exploit the operating system's memory protection mechanism to provide deterministic replay.

Suppose that there are two processes, A and B, that share some portion of memory M, such that both processes have read and write permissions to access M. Process A is being run under instrumentation for bidirectional or backwards debugging, but process B is not. The shared memory M is initially mapped such that process B has read-only access, and A has full access. We describe this situation as process A having ownership of memory M. Any attempt by process B to read memory M will succeed as normal, but any attempt by process B to write to M will result in a page fault. This fault is responded to by memory M being mapped read/write to process B, and unmapped completely from process A. We refer to this process B taking ownership of the memory. Here, any attempt to access M (either for reading or for writing) by A will result in a page fault. This is responded to by reverting ownership of M to A, but in addition sufficient state being stored in the event log to replay the changes to M made by B. That is, the difference of the memory M between the point when A last had ownership of that memory and the current time is stored in the event log.

When replaying, the difference in memory is retrieved from the event log and applied at the appropriate time. Thus the effect on A of B's asynchronous modification of memory M can be replayed deterministically.

Note that the above scheme can easily by generalised so that process B is actually a group of one or more processes.

An alternative approach is to record in the event log every memory read performed by A on the shared memory M. This has the advantage of being a simpler implementation, but depending on the usage of the shared memory may result in the recording of an unacceptable amount of state in the event log, as well as adversely affecting temporal performance.

We will next describe implementation and structure of the event log. As we have seen, there are several kinds of events that need to be recorded in the event log: Non-deterministic instruction results (including the return codes and memory modifications made by system calls), Asynchronous events (including asynchronous signal delivery), Thread Switches, and Shared memory transactions.

Preferably the memory used to store the event log is accessible by the process in record and replay mode. This means that if the UNIX fork facility is used to snapshot processes, then the memory used to store the event log should be shared between each process created with these forks. However preferably the event log (and all memory used by the instrumentation code) is not usable as the internal state of the program being debugged; to prevent this all memory transactions by the program being debugged can be intercepted by the instrumentation code, and access to memory used by the instrumentation code (including the event log) can be denied to the program being debugged.

Preferably the event log itself is stored as a linked list, where each node contains the type of event, data sufficient to reconstruct that event during replay, and the time at which that event happened (where time is based on the number of instructions executed to that point or some approximation thereof, preferably combined with the number of non-deterministic or asynchronous events executed to that point).

Then when in replay mode, between each basic block it is necessary only to inspect the current time, and compare it with the time of the next non-deterministic event in the event log. In the common case that the current time is less than the time for the next non-deterministic event, the coming basic block can be executed without further delay. If there is a non-deterministic event to replay in the coming basic block then the instrumentation must arrange for the effects of the said non-deterministic event to reconstructed at the corresponding time in the coming basic block.

We will next describe searching history. In general, it is more useful for a bidirectional or backwards debugger to be able to search history for a particular condition, as opposed to wind a program back to an absolute, arbitrary time. Some examples of the kinds of conditions it is useful to be able to search are:
1) The previously executed instruction
2) The previously executed source code line
3) The previously executed source code line at the current function call depth
4) The call site for the current function
5) The previous time an arbitrary instruction or source code line was executed

More generally, it is useful to be able to rewind a debugged program to the previous time an arbitrary condition held, such as a variable containing a given value, or even completely arbitrary conditions, such as some function returning a particular value.

We have implemented an algorithm to search an execution history for such arbitrary conditions. The most recent snapshot is taken, and played forward testing for the condition at the end of each basic block. Each time the condition holds, the time is noted (if a time is already recorded because the condition held earlier, it is overwritten). When the history is replayed up to the debug point, the most recent time at which the condition held will be stored. If no such time has been recorded because the condition did not hold since the most recent snapshot, then the search is repeated starting from the next most recent snapshot, up to the most recent snapshot. That is, suppose that the debugged program is currently positioned at time 7,000, and there are snapshots at times 0; 2,000; 4,000; and 6,000. We start at the snapshot at time 6,000 and play forwards until time 7,000, testing for the condition between each basic block. If the condition never holds between times 6,000 and 7,000, then we rewind to the snapshot taken at 4,000, and play that forwards to 6,000, searching for the event. If the condition still isn't found to hold, we check 2,000-4,000, and so on.

Note that this algorithm will not work reliably with the instrumentation technique of FIG. 4 if searching for the most recent time at which a variable held a particular value. This is because a variable's value may change to and then from the required value entirely within a basic block. To overcome this, there is an enhancement to the instrumentation technique shown in FIG. 4—each memory write operation is considered a basic block terminator. (This approach can also be used to ensure that a program that has gone hay-wire does not write over the event log or other instrumentation data structures.) This form of instrumentation will operate less efficiently than the one shown in FIG. 4; however should the performance become problematic, it is possible to run with both forms of instrumentation, switching between the two as necessary.

We have described a bidirectional or backwards debugging mechanism that can be conveniently implemented on most modern operating systems for example including, but not limited to, Linux and Windows®. A process can be rewound and its state at any time in its history can be examined. This is achieved by regularly snapshotting the process as it runs, and running the appropriate snapshot forward to find the process' state at any given time. Non-determinism may be removed using a machine code instrumentation technique.

Our technique of instrumenting machine code rather than source-level analysis is particularly important, because it means the system copes with bugs where the compiler-dictated control flow is subverted (e.g. overwriting a function's return address on the stack).

The processing described above provides a particularly beneficial way to record execution of a computer program. Those skilled in the art will readily appreciate that other techniques to record execution of a program for debugging are also possible. In any event, once a recording is obtained, techniques to analyze the recording to diagnose and resolve bugs are needed.

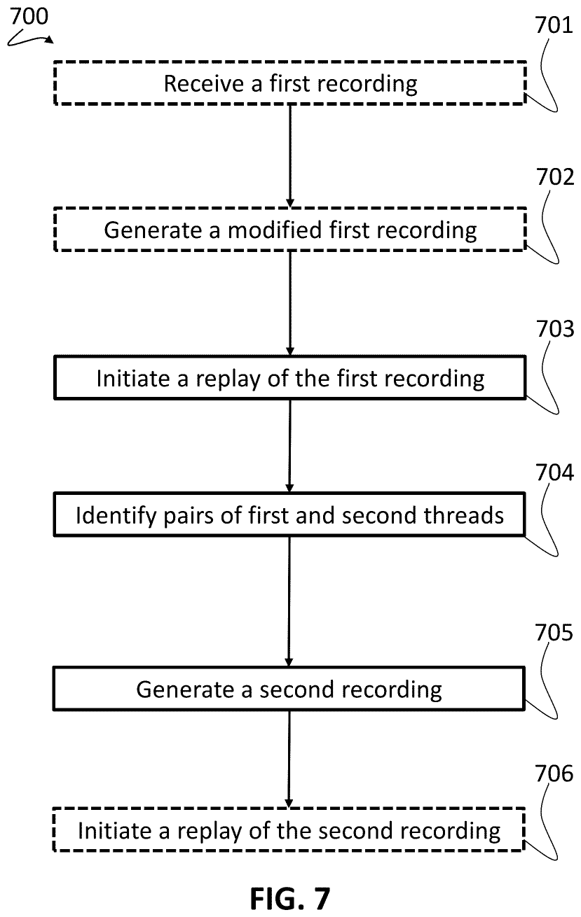

FIG. 7 is a flowchart of an example method 700 for analysing a computer program. At optional step 701, a first recording may be received. At step 702, a modified first recording is generated. At step 703, a replay of the first recording is initiated. At step 704, pairs of first and second threads are identified. At step 705, a second recording is generated. At optional step 706, a replay of the second recording is initiated.

As discussed above, a program executing multiple threads may show non-determinism. As a result of such non-determinism, a program that demonstrates anomalous behaviour may not consistently demonstrate anomalous behaviour. This may prevent the anomalous behaviour from being understood or slow down a process used to understand causes of the anomalous behaviour.

Beneficially, the example method 700 (discussed below in relation to FIG. 7) may provide a way of recreating anomalous behaviour in programs that are executing using multiple threads. In this way, the cause of the anomalous behaviour may be understood, and resolved, quicker than otherwise.

Of particular benefit, is that the first recording may not need to demonstrate the anomalous behaviour itself. Thus, the method 700 may be used to resolve anomalous behaviour in cases where the anomalous behaviour has not been captured in the first recording.

As discussed above, threads may be time-sliced onto a single processor. Alternatively, threads may be run in parallel on a multiprocessor system. It will be appreciated that the method 700 may be used to recreate anomalous behaviour relating to either of these types of threads. Likewise, the method 700 may be used in relation to user-managed threads and/or kernel-managed threads.

At step 701, a first recording may be received. As mentioned above, step 701 is an optional step. The optional nature of this step is indicated by a dashed line in FIG. 7. This convention is also used with other diagrams in this specification.

The first recording may be a recording of an execution of a computer program. In general, the first recording may be any recording that allows a corresponding instrumented program to be run. For example, the first recording may comprise one or more snapshots as shown in FIG. 1. Additionally or alternatively, the first recording may comprise one or more basic blocks.

It will be appreciated that, as an alternative to receiving the first recording (at step 701), the first recording may be recorded. That is, the program may be first executed and the first execution may be recorded. During the first execution, the basic blocks and snapshots may be copied to form the first recording. As an example, the first recording may be recorded by use of a recording component of a backwards debugger.

The first recording may be a recording of a portion of the execution of the computer program. In other words, the recording may not be a recording of the computer program being executed in its entirety.

In some examples, the first recording may be indicative of a bug (i.e. an instance of anomalous behaviour). That is, the recording may demonstrate the bug occurring. In other examples, the recording may not demonstrate the bug occurring. That is, by use of the method, a bug may be recreated or found without being the bug itself being demonstrated in the first recording. It will be appreciated that for a bug to be investigated using the method 700, execution of code corresponding to the bug must be executed in the first recording, even if the bug does not occur in the first recording.

At step 702, a modified first recording is generated. That is, the modified first recording may be generated from the first recording. The modified first recording may be generated 702 according to the method 800. As discussed below in more detail, the modified first recording may be replayed in a tracee process. The modified first recording may be a recording that is loaded into memory of the tracee process. That is, the first recording may be loaded into the memory of the tracee process and, after being loaded, the modified first recording may be generated. In other words, the modified first recording may be ephemeral (i.e. not saved to disk).

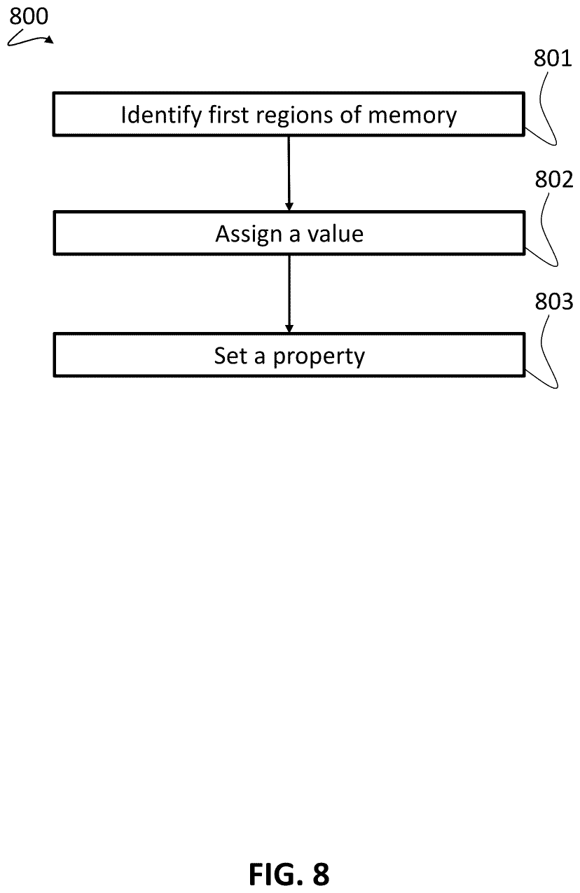

FIG. 8 is a flowchart of an example method 800 for generating a modified first recording. At step 801, first regions of memory are identified. At step 802, a value is assigned. At step 803, a property is set.

At step 801, first regions of memory are identified. The first regions of memory may be regions of memory accessed by the execution of the computer program that is recorded in the first recording. That is, each region of memory that stores a value that is read or written by execution of the computer program may be identified.

In particular, each of the first regions of memory may be writeable regions of memory i.e. regions of memory that have a write permission. For example, each region of memory may have a PROT_WRITE permission. As such, identifying (at step 801) the first regions of memory may comprise identifying each region of memory that has a write permission.

As a further example, the first regions of memory may exclude memory of a stack of a main thread. That is, in a program executing multiple threads, there may be a main thread from which the other ones of the multiple threads are created. Thus, the main thread may not be created by the other ones of the multiple threads. The stack of the main thread may be accessed multiple times by the main thread. Typically, the stack of the main thread will not be accessed many times by the other ones of the multiple threads. Thus, in the interests of improving performance, the memory of the stack of the main thread may not be identified as regions of memory.

It will be appreciated that there may be one or more first regions of memory. In some examples, there may be a plurality of first regions of memory.

The steps 802 and 803, discussed below, may each be performed for each first region of memory that is identified at step 801.

At step 802, a value is assigned. That is, the value that is stored in the first region of memory may be assigned to a second region of memory. Assigning a value may comprise copying the value that is at the first region of memory to the second region of memory. Thus, each first region of memory may have a corresponding second region of memory.

The value that is stored in the first region of memory may be the value that is stored in the first region of memory at a first recording time point. The first recording time point may be a time point at the start of the first recording. As discussed below in more detail, the replay of the first recording may be initiated partway through. In such examples, the first recording time point may be a time point when the replay of the first recording is to be initiated.

At step 803, a property is set. The property may be a property of the first region of memory. As an example, the property may be an access permission. That is, the property may be set such that an access condition will occur should there be an attempt to access the first region of memory during replay of the modified first recording.

The access condition may be any appropriate condition. In particular, the access condition occurring may cause one or more properties of the process attempting to access the first region of memory to be provided to a parent process. As discussed below, the process that replays the first generated recording may be a tracee process. The access condition may cause one or more properties of the tracee process to be provided to a corresponding tracer process. For example, the one or more properties may comprise an address of the first region of memory. Additionally or alternatively, the one or more properties may comprise an identifier of a thread that has attempted to access the first region of memory. Additionally or alternatively, the one or more properties may comprise a program counter value corresponding to an instruction to attempt access of the first region of memory. As an example, the access condition may be a segmentation fault. The access condition may cause a SIGSEGV signal.

In some examples, setting the access permission may comprise removing a read permission. Additionally or alternatively, setting the access permission may comprise removing a write permission and/or execution permission. In particular, the access permission of the first region of memory may be set such that the memory cannot be accessed at all. For example, the access permission may be set to PROT_NONE.

The access permission may be an access permission for a process corresponding to the replay of the first recording. That is, the process corresponding to the replay of the first recording may be prevented from accessing the first region of memory.

Thus, by use of the method 800 a modified first recording may be generated.

Returning to FIG. 7 and the method 700, at step 703, a replay of the first recording is initiated. That is, the modified first recording (i.e. the modified recording generated at step 702) may be replayed.

It will be appreciated that the replay of the first recording may be a partial replay. In other words, the modified first recording may not be replayed entirely.

It will also be appreciated that the replay may be initiated at any appropriate time point. For example, where there is some prior knowledge of the anomalous behaviour (or the code that is causing the anomalous behaviour), the replay of the first recording may be initiated at a time point near to the anomalous behaviour. In other words, initiating the replay of the first recording may comprise initiating replay partway through the modified first recording.

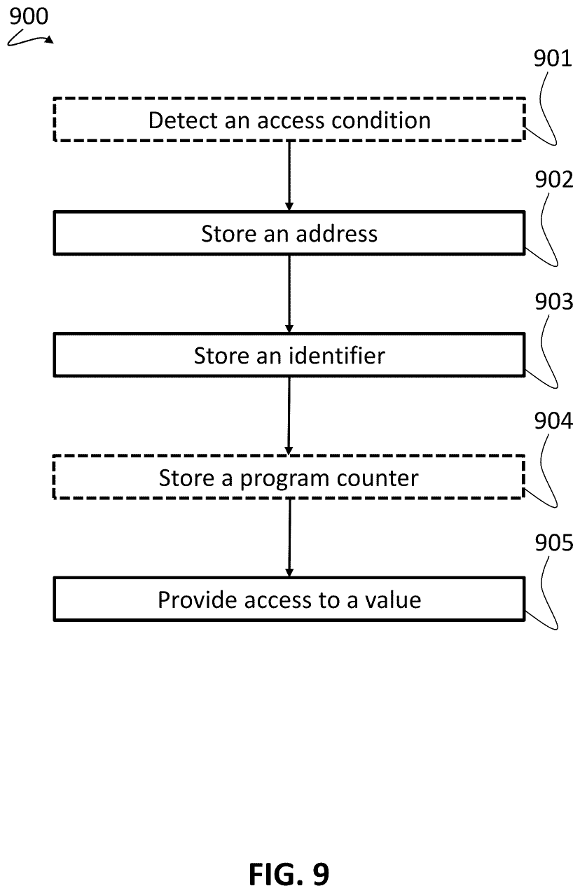

FIG. 9 is a flowchart of an example method 900 of replaying a recording of an execution of the computer program. The replay of the first recording, once initiated at step 703, may be performed in accordance with the method 900. The steps (i.e. steps 901, 902, 903, 904, and 905) of the method 900 may be performed for each access attempt to each one of the first regions of memory. At step 901, an access condition may be detected. At step 902, an address is stored. At step 903, an identifier is stored. At optional step 904, a program counter value is stored. At step 905, access to a value is provided.

Replaying the modified first recording may comprise running an instrumented program, as discussed above. That is, the modified first recording may be used to run an instrumented program. In particular, a first process may run the recording of the execution process. The first process may be a tracee of a second process. Thus, the first process may be referred to as a tracee process and the second process may be referred to as a tracer process. That is, the tracer process may be able to observe and control execution of the tracee process.

As an example, the tracer process may use the ptrace Linux kernel API. Through this API, the tracer process may be able to coordinate the tracee process. For example, the tracer process may wait until a condition has occurred in the tracee process. In particular, the tracer process may wait using the wait system call.

At step 901, an access condition may be detected. The access condition may be caused by the replay of the modified first recording. In other words, the access condition may be caused by the instrumented program being ran by the tracee process. The access condition may occur in response to an attempt to access the first region of memory and the property of the first region of memory that was set at step 803. As discussed above, the access condition may be a segmentation fault. The access condition may be detected by the tracer process. For example, the tracer process may be notified that the segmentation fault has occurred in the tracee process.

In response to the access condition being detected, the tracer process may modify the tracee process. In particular, the tracer process may use ptrace functions to modify the tracee process such that each of the steps 902, 903, 904 and 905 are performed by the tracer process. As such, for each of the steps 902, 903, 904, and 905, the method 900 may further comprise corresponding steps of modifying a tracee process to perform the step. For example, the method may, prior to the step 902 of storing the address, comprise a step of modifying a tracee process to store an address.

As an example, the poke functions (e.g. PTRACE_POKEDATA) and/or the the setegs functions (e.g. PTRACE_SETREGS) may be used to modify the tracee process. After the tracer process has modified the tracee process, the tracer process may cause the tracee process to be resumed. For example, the PTRACE_CONT function may be used.

Through modification and resumption of the tracee process, each of the steps 902, 903, 904, and 905 may be performed in response to the access condition being detected at step 901. In some examples, all of the steps 902, 903, 904 and 905 are performed in response to the access condition being detected at step 901.

In some examples, the modifications made to the tracee process may persist for a time period. That is, the modifications made to the tracee process by the tracer process may be reverted after the time period. The reversion may be automatic or may be handled by the tracer process. Thus, if a first region of memory is accessed multiple times within the time period, the access condition may only be detected a single time. As such, the tracee process may only be modified once for each of the multiple accesses of the first region of memory within the time period. Having been modified, the tracee process may perform the steps 902, 903, 904 and 905 for each access attempt in the time period.

At step 902, an address is stored. The address may be stored by the tracee process. The address may be an address of a first region of memory for which access has been attempted by the tracee process.

In some examples, the address may be a rounded address. Beneficially, by use of rounding, a size of memory used to store the address may be reduced.

At step 903, an identifier is stored. The identifier may be stored by the tracee process. The identifier may be an identifier of a thread that has attempted to access the first region of memory. In some examples, the identifier may be a rounded identifier.

At optional step 904, a program counter value is stored. In other words, the program counter value may be a memory address of an instruction. In particular, the program counter value may indicate which instruction caused the attempt to access the first region of memory. The program counter value may be stored by the tracee process. The program counter value may be a raw value. Alternatively, the program counter value may be an offset value. That is, the program counter value may indicate a value relative to a memory map containing information about the code. Beneficially, by using the program counter value in this way, the method may be robust to address space layout randomization (ASLR).

The stored values (e.g. the address and the identifier that are stored at steps 902 and 903, respectively) may be stored in any appropriate format and/or data structure. For example, the address and the identifier may be stored in a map. More generally, the values may be stored in any way that allows each stored address to be associated with the corresponding stored identifier. In examples in which a program counter value is stored, the program counter value may be stored in a similar way.

At step 905, access to a value is provided. As discussed above at step 803, each value that was stored in each first region of memory is assigned to a corresponding second region of memory. Thus, by modifying the tracee process to access the corresponding second region of memory, the replay of the modified first recording may continue in a same/similar way to the original execution of the computer program.

Returning to FIG. 7 and the method 700, at step 704, pairs of first and second threads are identified. That is, pairs of first and second threads that attempted to access a same first region of memory during the replay of the first recording are identified. For example, the address of the first region of memory (stored at step 902) and the identifiers of threads (stored at step 903) may be analysed to find pairs of threads that attempted to access the same first region of memory.

It will be appreciated that any number of multiple threads may be identified. For example, five threads may have attempted to access the same first region of memory. In such examples, the order of scheduling of the five threads may be changed when generating a second recording.

The method 700 may further comprise identifying the first regions of memory for which access was attempted. For example, a pair of first and second threads may be identified at step 704 (as discussed above) and the corresponding first region of memory may be identified.

The method 700 may further comprise identifying one or more program counter values. For example, a program counter value may be identified for each thread of the pair of first and second threads. The one or more program counter values may be identified based on the program counter values that are stored at step 904. That is, after a pair of first and second threads has been identified, an instruction that caused each of the threads to attempt access to the same first region of memory may be identified. An indication of the instruction may be output to the user.

At step 705, a second recording is generated. The second recording may be generated by recording an execution of the computer program. That is, the first and second recordings may both be recordings of respective executions of the same computer program. As discussed above in relation to the first recording, the basic blocks and snapshots may be copied to form the second recording. The second recording may be recorded by use of a recording component of a backwards debugger.

When generating (at step 705) the second recording, the order in which each pair of first and second threads (that were identified at step 704) is scheduled may be changed compared to an order in which the threads were scheduled in either the first recording or the modified first recording. That is, when generating (at step 705) the second recording, the non-deterministic portions of the computer program may be executed in a different order to that of the first recording. It will be appreciated that the order may be changed in any appropriate manner. In some examples, the order may be changed based on the identifiers of the identified first and second threads. Additionally or alternatively, the order may be changed based on the identified one or more program counter values.

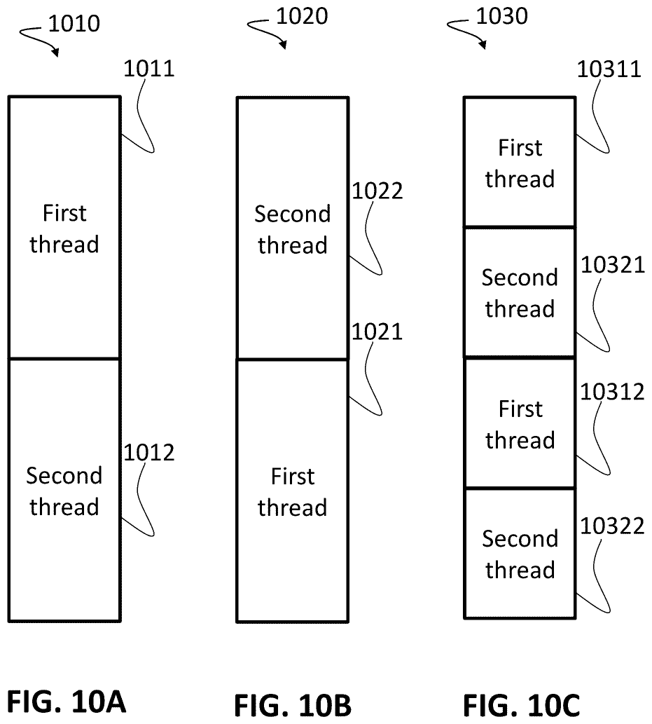

FIGS. 10A, 10B and 10C show a respective first, second and third order of scheduling threads.

FIG. 10A shows a first order 1010. That is a first thread 1011 is processed. Subsequent to the first thread 1011 being processed, a second thread 1012 is processed. The first order 1010 may correspond to an order in which the first thread 1011 and the second thread 1012 are processed in a replay of the first recording, such as the replay that is initiated at step 703.

The first thread 1011 and the second thread 1012 may have accessed the same region of memory and thus may have been identified as a pair at step 704. In generating the second recording, the order in which the threads are scheduled may be changed. FIGS. 10B and 10C show examples of changed orders.

FIG. 10B shows a second order 1020. In the second order 1020, the second thread 1022 is processed. Subsequent to the second thread 1022 being processed, the first thread 1021 is processed. In other words, the order is reversed.

FIG. 10C shows a second order 1030. In the third order, a first portion of the first thread 10311 is processed. Subsequently, a first portion of the second thread 10321 is processed. Subsequently, a second portion of the first thread 10312 is processed. Subsequently, a second portion of the second thread 10322 is processed. In other words, the order in which portions of threads are processed is changed.

Returning to FIG. 7, at step 706, a replay of the second recording is initiated. As the second recording exhibits the changed scheduling order of the first and second threads, concurrency bugs may be reproduced quicker than otherwise.

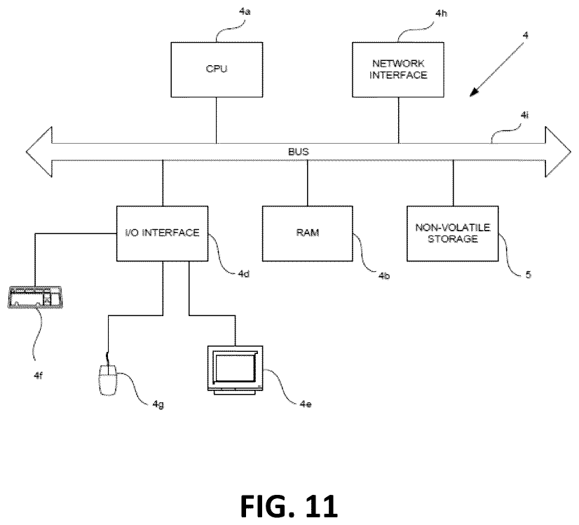

FIG. 11 schematically illustrates an exemplary arrangement of components which may provide a computing system 4 used to implement all or part of the techniques described above. For example, the computing system 4 may be used to execute or more of the machine learning models described above, such as the sequence model of FIG. 7. The computing system 4 may additionally or alternatively be used to obtain a recording of an execution of a computer program for analysis by a machine learning model, as described with reference to FIGS. 1-6. Additionally or alternatively, the computing system 4 may be used to run one or more computer programs providing a user interface to enable a user to debug a computer program using the techniques described herein, e.g. to display the results of analysis performed using the techniques described herein.

A processor, in this case in the form of a CPU 4a, configured to read and execute instructions stored in a volatile memory 4b which takes the form of a random access memory. It will be appreciated that the processor may take other forms, such as, for example, a GPU. The volatile memory 4b stores instructions for execution by the CPU 4a and data used by those instructions.

The computing system 4 comprises a storage device 5. It will be appreciated that the storage device 5 may be implemented in any way, such as for example, a hard disk drive, a solid state drive, etc. The computing system 4 further comprises an I/O interface 4d to which are connected peripheral devices used in connection with the computing system. More particularly, a display 4e is configured so as to display output. Input devices are also connected to the I/O interface 4d. Such input devices include a keyboard 4f and a mouse 4g which allow user interaction with the computing system 4. A network interface 4h allows the computing system 4 to be connected to appropriate computer networks, such as the Internet 6. The CPU 4a, volatile memory 4b, the storage device 5, I/O interface 4d, and network interface 4h, are connected together by a bus 4i.

Although specific embodiments of the invention have been described above, it will be appreciated that various modifications can be made to the described embodiments without departing from the spirit and scope of the present invention. That is, the described embodiments are to be considered in all respects exemplary and non-limiting. In particular, where a particular form has been described for particular processing, it will be appreciated that such processing may be carried out in any suitable form arranged to provide suitable output data.

Any system feature as described herein may also be provided as a method feature, and vice versa. As used herein, means plus function features may be expressed alternatively in terms of their corresponding structure.

Any feature in one aspect may be applied to other aspects, in any appropriate combination. In particular, method aspects may be applied to system aspects, and vice versa. Furthermore, any, some and/or all features in one aspect can be applied to any, some and/or all features in any other aspect, in any appropriate combination.

It should also be appreciated that particular combinations of the various features described and defined in any aspects can be implemented and/or supplied and/or used independently.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “processor”, “computer” or “computing device” generally refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, logic, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a mark-up language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, the subject matter described in this specification can be implemented on a computer having a display device, e.g., a CRT (cathode ray tube) or LCD (liquid crystal display) monitor, for displaying information to the user and a keyboard and a pointing device, e.g., a mouse or a track-ball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework or other.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

A computing system can include clients and servers as illustrated in FIG. 1. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer-implemented method for analysing a computer program to identify anomalous execution, comprising:
initiating a replay of a first recording of an first execution of the computer program;
during the replay of the first recording, for each access attempt to each one of one or more first regions of memory:
storing an address of the first region of memory;
storing an identifier of a thread attempting to access the first region of memory; and
providing access, to the thread, to a value that was stored in the first region of memory at the time of the access attempt;
identifying, based on the stored addresses and the stored identifiers, one or more pairs of first and second threads that attempted to access a same first region of memory during the replay of the first recording;
generating a second recording of an second execution of the computer program comprising, during the second execution and for each of the identified one or more pairs of first and second threads:
processing the first and second threads in a different order to that processed in the first execution; and
initiating a replay of the second recording.

2. The method of claim 1 further comprising:
generating, from a first recording of an execution of the computer program, a modified first recording; and wherein:
initiating the replay of the first recording comprises initiating replay of the modified first recording.

3. The method of claim 2 wherein generating the modified first recording, comprises:
identifying the one or more first regions of memory as regions of memory accessed by an execution of a computer program in the first recording; and
for each one of the one or more first regions of memory:
assigning a value stored in the first region of memory at a first recording time point to a corresponding second region of memory; and
setting a property of the first region of memory to cause an access condition to occur upon attempted access of the first region of memory during a replay of the modified first recording;
wherein, the method further comprises, during the replay of the first recording:
detecting the access condition.

4. The method of claim 3 wherein:
the address of the first region of memory is stored in response to the access condition being detected.

5. The method of claim 3 wherein:
the identifier of the thread attempting to access the first region of memory is stored in response to the access condition being detected.

6. The method of claim 3 wherein:
access is provided, to the thread, to the value that was stored in the first region of memory in the first recording at the time of the access attempt in response to the access condition being detected.

7. The method of claim 6 wherein providing access, to the value that was stored in the first region of memory in the first recording at the time of the access attempt comprises:
providing access to the corresponding second region of memory.

8. The method of claim 3 wherein setting the property of the first region of memory comprises:
setting an access permission of the first region of memory.

9. The method of claim 1 further comprising, during the replay of the first recording, for each access attempt:
storing a program counter value.

10. The method of claim 9 further comprising:
identifying, based on the stored program counter values and the stored addresses, one or more program counter values corresponding to attempts to access the same first region of memory during the replay of the first recording; and
outputting an indication of the one or more program counter values.

11. The method of claim 2 wherein:
generating the modified first recording comprises scheduling the first and second threads in a first order; and
generating the second recording comprises scheduling the first and second threads in a second order.

12. The method of claim 2 further comprising:
generating the first recording.

13. The method of claim 2 further comprising:
receiving the first recording.

14. The method of claim 1 wherein storing the address of the first region of memory comprises:
storing a rounded address of the first region of memory.

15. The method of claim 1 wherein storing the identifier of a thread attempting to access the first region of memory comprises:
storing a rounded identifier of the thread attempting to access the first region of memory.

16. A computer system comprising:
a memory storing processor readable instructions; and
a processor arranged to read and execute instructions stored in the memory; wherein the processor readable instructions are arranged to cause the processor to:
initiate a replay of a first recording of an first execution of a computer program;
during the replay of the first recording, for each access attempt to each one of one or more first regions of memory:
store an address of the first region of memory;
store an identifier of a thread attempting to access the first region of memory; and
provide access, to the thread, to a value that was stored in the first region of memory at the time of the access attempt;
identify, based on the stored addresses and the stored identifiers, one or more pairs of first and second threads that attempted to access a same first region of memory during the replay of the first recording;
generate a second recording of an second execution of the computer program comprising, during the second execution and for each of the identified one or more pairs of first and second threads:
process the first and second threads in a different order to that processed in the first execution; and
initiate a replay of the second recording.

17. A non-transitory computer readable medium comprising processor readable instructions, wherein the processor readable instructions are arranged to cause a processor to:
initiate a replay of a first recording of an first execution of a computer program;
during the replay of the first recording, for each access attempt to each one of one or more first regions of memory:
store an address of the first region of memory;
store an identifier of a thread attempting to access the first region of memory; and
provide access, to the thread, to a value that was stored in the first region of memory at the time of the access attempt;
identify, based on the stored addresses and the stored identifiers, one or more pairs of first and second threads that attempted to access a same first region of memory during the replay of the first recording;
generate a second recording of an second execution of the computer program comprising, during the second execution and for each of the identified one or more pairs of first and second threads:
process the first and second threads in a different order to that processed in the first execution; and
initiate a replay of the second recording.
